(19) United States
(12) Patent Application Publication
(10) Pub. No.: US 2026/0239148 A1
(43) Pub. Date: Aug. 13, 2026

(54) Configuration for Layer 1/Layer 2 Triggered Mobility

(71) Applicant: Telefonaktiebolaget LM Ericsson (publ), Stockholm (SE)

(72) Inventors: Ioanna Pappa, Stockholm (SE); Antonino Orsino, Kirkkonummi (FI); Julien Muller, Rennes (FR); Liwei Qiu, Täby (SE)

(21) Appl. No.: 19/472,928

(22) PCT Filed: Apr. 5, 2024
(86) PCT No.: PCT/SE2024/050328

§ 371 Date: Oct. 6, 2025

Related U.S. Application Data
(60) Provisional application No. 63/457,479, filed on Apr. 6, 2023.

(51) Int. Cl. H04W 36/32; H04L 61/10

(52) U.S. Cl. CPC H04W 36/324; H04L 61/10

(57) ABSTRACT

In an example, a method performed by a central unit-control plane (CU-CP) network node is provided. The method comprises sending, to a central unit-user plane (CU-UP) network node, a message identifying a configuration of the CU-UP network node for a Layer 1/Layer 2-triggered mobility (LTM) cell switch procedure by a User Equipment (UE).

### TECHNICAL FIELD

Examples of this disclosure relate to Layer 1/Layer 2 triggered mobility (LTM), for example sending or receiving a message identifying a configuration of a network node for a LTM cell switch procedure by a User Equipment (UE), or receiving one or more transport network layer (TNL) addresses that have been assigned to one or more LTM candidate target cells.

### BACKGROUND

In Rel-18, 3GPP has agreed on a Work Item on Further New Radio (NR) mobility enhancements, in particular, in a technical area entitled L1/L2 based inter-cell mobility. See the work item description (WID) in RP-213565 for further details.

According to the WID, when the user equipment (UE) moves from the coverage area of one cell to another cell, at some point a serving cell change needs to be performed. Currently, serving cell change is triggered by Layer 3 (L3) measurements and is done by Radio Resource Control (RRC) signalling triggered Reconfiguration with Synchronization for change of Primary Cell (PCell) and Primary Secondary Cell (PSCell), as well as release or add for Secondary Cells (SCells) when applicable. All cases involve complete Layer 2 (L2) and Layer 1 (L1) resets, leading to longer latency, larger overhead and longer interruption time than beam switch mobility. The goal of L1/L2 mobility enhancements is to enable a serving cell change via L1/L2 signalling, in order to reduce the latency, signalling overhead and interruption time.

As part of L1-L2 inter-cell mobility measurement framework, it was agreed to support at least L1-Reference Signal Receive Power (L1-RSRP) as the reporting quantity. That means UE is required to report L1-RSRP of the candidate cells to the network (NW), so that NW can use them for LTM handover (HO) decisions.

In Rel-17, as part of inter-cell beam management, a solution has been standardized where L1-RSRP is measured and reported on a Channel State Information (CSI) resource that are not associated to a Physical Cell Identifier (PCI) of the serving cells.

The L3 HO delay requirements from 3GPP TS 38.133 V18.0.0 are copied below.

### 6.1.1.2.1 Handover Delay

When the UE receives a RRC message implying handover the UE shall be ready to start the transmission of the new uplink PRACH channel within D_{handover} msec from the end of the last TTI containing the RRC command.

### Where:

D_{handover} equals the applicable RRC procedure delay defined in clause 12 in TS 38.331 [2] plus the interruption time stated in clause 6.1.1.2.2.

### 6.1.1.2.2 Interruption Time

The interruption time is the time between end of the last TTI containing the RRC command on the old PDSCH and the time the UE starts transmission of the new PRACH, excluding the RRC procedure delay.

When intra-frequency or inter-frequency handover is commanded, the interruption time shall be less than Tᵢₙₜₑᵣᵣᵤₚₜ

$${T}_{interrupt} = {T}_{search} + {T}_{IU} + {T}_{processing} + {T}_{Δ} + {T}_{margin} ms$$

### Where:

T_{search} is the time required to search the target cell when the target cell is not already known when the handover command is received by the UE. If the target cell is known, then T_{search}=0 ms. If the target cell is an unknown intra-frequency cell and the target cell Es/lot≥−2 dB, then T_{search}=Tᵣₛ ms. If the target cell is an unknown inter-frequency cell and the target cell Es/lot≥−2 dB, then T_{search}=3*Tᵣₛ ms. Regardless of whether DRX is in use by the UE, T_{search} shall still be based on non-DRX target cell search times.

T_{Δ} is time for fine time tracking and acquiring full timing information of the target cell. T_{Δ}=Tᵣₛ for both known and unknown target cell.

T_{processing} is time for UE processing. T_{processing} can be up to 20 ms.

T_{margin} is time for SSB post-processing. T_{margin} can be up to 2 ms.

T_{IU} is the interruption uncertainty in acquiring the first available PRACH occasion in the new cell. T_{IU} can be up to the summation of SSB to PRACH occasion association period and 10 ms. SSB to PRACH occasion associated period is defined in the table 8.1-1 of TS 38.213 [3].

Tᵣₛ is the SMTC periodicity of the target NR cell if the UE has been provided with an SMTC configuration for the target cell in the handover command, otherwise Trs is the SMTC configured in the measObjectNR having the same SSB frequency and subcarrier spacing. If the measObjectNRs having the same SSB frequency and subcarrier spacing configured by MN and SN have different SMTC, Trs is the periodicity of one of the SMTC which is up to UE implementation. If the UE is not provided SMTC configuration or measurement object on this frequency, the requirement in this clause is applied with Tᵣₛ=5 ms assuming the SSB transmission periodicity is 5 ms. There is no requirement if the SSB transmission periodicity is not 5 ms. If the UE has been provided with higher layer in TS 38.331 [2] signaling of smtc2 prior to the handover command, Tᵣₛ follows smtc1 or smtc2 according to the physical cell ID of the target cell.

In the interruption requirement a cell is known if it has been meeting the relevant cell identification requirement during the last 5 seconds otherwise it is unknown. Relevant cell identification requirements are described in Clause 9.2.5 for intra-frequency handover and Clause 9.3.4 for inter-frequency handover.

As per the above requirements shown, L3 HO delay (D_{handover}) equals the RRC processing delay of the HO command and the interruption time. The interruption delay comprises the following components:
SW and HW processing
Cell search
Acquisition of fine timing
Delay uncertainty of obtaining PRACH preamble

As per the initial discussions of Rel-18 LTM, two potential approaches and two potential timelines are discussed.

In 3GPP Release 18, a work item known as Further NR mobility enhancements has been agreed. This work item includes a technical area entitled L1/L2-based inter-cell mobility. According to the WID, when the UE moves from the coverage area of one cell to another cell, at some point a serving cell change needs to be performed. Currently serving cell change is triggered by L3 measurements and is done by RRC signalling triggered Reconfiguration with Synchronisation for change of PCell and PSCell, as well as release add for SCells when applicable. All cases involve complete L2 and L1 resets, leading to longer latency, larger overhead and longer interruption time than beam switch mobility. The goal of L1/L2 based inter-cell mobility is to enable a serving cell change via L1/L2 signalling, in order to reduce the latency, overhead and interruption time.

In this work item, according to the WID, the following is included as one objective of the work:
1. To specify mechanism and procedures of L1/L2 based inter-cell mobility for mobility latency reduction:
   Configuration and maintenance for multiple candidate cells to allow fast application of configurations for candidate cells [RAN2, RAN3]
   Dynamic switch mechanism among candidate serving cells (including SpCell and SCell) for the potential applicable scenarios based on L1/L2 signalling [RAN2, RAN1]
   L1 enhancements for inter-cell beam management, including L1 measurement and reporting, and beam indication [RAN1, RAN2]
      Note 1: Early RAN2 involvement is necessary, including the possibility of further clarifying the interaction between this bullet with the previous bullet
   Timing Advance management [RAN1, RAN2]
   CU-DU interface signaling to support L1/L2 mobility, if needed [RAN3]
   Note 2: FR2 specific enhancements are not precluded, if any.
   Note 3: The procedure of L1/L2 based inter-cell mobility are applicable to the following scenarios:
      Standalone, CA and NR-DC case with serving cell change within one CG
      Intra-DU case and intra-CU inter-DU case (applicable for Standalone and CA: no new RAN interfaces are expected).
      Both intra-frequency and inter-frequency
      Both FR1 and FR2
      Source and target cells may be synchronized or non-synchronized

In 3GPP, discussions have started on solutions for L1/L2 based inter-cell mobility (sometimes also referred to as LTM, L1/L2-triggered mobility or lower layer-triggered mobility).

A basic principle with L1/L2-triggered mobility is that the UE is pre-configured, by the network, with an RRC configuration per LTM candidate target cell, sometimes also known as a LTM candidate target cell configuration. Such a LTM candidate target cell configuration may be an RRCReconfiguration message or one or more IEs/fields/parameters such as CellGroupConfig. The UE performs measurements on these candidate LTM candidate target cells and transmits corresponding measurement reports to the network. The network then triggers the execution LTM cell switch in the UE by transmitting a lower layer signal (such as a MAC CE or DCI), to the UE, which then connects to the target cell and switches to a configuration of an LTM candidate target cell.

At the RAN3 #117-e, RAN3 #117bis-e, RAN3 #118 and RAN3 #119 meetings, there were multiple agreements made on L1/L2 based inter-cell mobility, and among these are the following:
Both intra-DU and intra-CU/inter-DU scenarios are supported for L1/L2 mobility.
RAN3 will aim for a single solution for network signaling design on L1/L2 based inter-cell mobility to support all agreed scenarios. The details of solution are FFS.
The gNB-CU initiates the L1/L2 mobility configuration procedure.
The configuration of candidate target cell(s) for L1/L2 mobility is initiated by the gNB-CU. WA: RAN3 assumes that the UE sends the L1 measurement report to the gNB-DU and the gNB-DU triggers UE mobility to a target candidate cell. All details are up to RAN1 and RAN2 discussion.
During L1/L2 handover configuration, the gNB-CU sends the suggested candidate cell(s) to the gNB-DU in UE Context Modification Request procedure, FFS in one message or multiple messages.
The gNB-DU may accept the target cells of L1/L2 handover and responds to the gNB-CU with the access control result in UE Context Modification Response message(s). gNB-DU may accept all or part of the target candidate cells.
gNB-DU initiated L1/L2 handover configuration is not allowed.
The UE sends the lower-layer measurement report to the gNB-DU and the gNB-DU triggers UE mobility to a target candidate cell.
WA: The gNB-DU indicates the gNB-CU about the UE successful access to the target cell by Access Success message.
For inter-DU inter-cell mobility, the UE Context Setup procedure is reused for handover configuration.
CU suggest the candidate cell(s) to DU, “gNB-DU can suggest candidate cells after the gNB-CU initiates the L1/L2 inter-cell mobility configuration” is with low priority.
CU can update the suggested candidate cells.
For intra-DU case, the gNB-DU indicates the gNB-CU about the UE successful access to the target cell by Access Success message.
For inter-DU case, the target gNB-DU indicates the gNB-CU about the UE successful access to the target cell by Access Success message.
RAN3 works on the same signaling procedure for both initial cell switch and subsequent cell switch for intra-DU L1/L2 handover.
During execution phase, it is up to the gNB-DU implementation when will the gNB-DU signal to the CU. This does not mean that the gNB-DU is “allowed” to signal to the gNB-CU before LTM command is sent to the UE.
For intra-DU LTM, the gNB-CU assigns a new UL GTP TEID for each DRB and provides it to the gNB-DU via UE Context Modification Request message(s). The gNB-DU assigns the new DL GTP TEIDs per DRB per candidate cell (whether it should be per candidate cell needs to be further discussed) and provides them back to the gNB-CU in UE Context Modification Response message(s).
For inter-DU LTM, the gNB-CU assigns a new UL GTP TEID for each DRB and provides it to the target gNB-DU via UE Context Setup Request message(s). The target gNB-DU assigns the new DL GTP TEIDs per DRB per candidate cell (whether it should be per candidate cell needs to be further discussed) and provides them back to the gNB-CU in UE Context Setup Response message(s).
Intra-CU UP case: CU will start data transmission after LTM cells switch signaling from DU including target cell ID.

There currently exist certain challenge(s). For example, one of the goals of LTM is to reduce user plane (UP) interruption time during handover (HO). However, in case of control plane (CP)/UP split, the exchange of GPRS Tunnelling Protocol (GTP)-U tunnel endpoints for F1-U tunnels, between target Distributed Unit (DU) and CU-UP, and through the CU-CP, can only be started once the target DU detects that the UE has successfully accessed the target cell. In the meantime, the CU-UP and the DU will have to buffer DL and UL data respectively. This will add extra user plane (UP) interruption time during LTM.

### SUMMARY

Certain aspects of the disclosure and their embodiments may provide solutions to these or other challenges. For example, in order to address the above challenges, some embodiments provide methods that enable the exchange of GTP-U tunnel endpoints for F1-U tunnels between the CU-UP and the target DU, so that the CU-UP and the DU can send DL and UL data respectively as early as possible. Some embodiments provide methods for the provision of a transport network layer (TNL) address by the CU-UP in the case of LTM. Some embodiments provide methods that ensure minimal impact to the CU-UP in the case of LTM. In some embodiments, the CU-UP provides only one UL TNL to all the candidate cells. In some embodiments, the candidate cells receive the UL TNL, but only the cell that will be chosen at the LTM cell switch will be allowed to use it. In some embodiments, the method further comprises signaling to the rest of the cells that the UL TNL address should be discarded after the UE has accessed the target cell. Certain embodiments may enable UP interruption time to be reduced for LTM.

One aspect of the present disclosure provides a method performed by a central unit-control plane, CU-CP, network node. The method comprises sending, to a central unit-user plane, CU-UP, network node a message identifying a configuration of the CU-UP network node for a Layer 1/Layer 2-triggered mobility, LTM, cell switch procedure by a User Equipment, UE.

Another aspect of the present disclosure provides a method performed by a central unit-user plane, CU-UP, network node. The method comprises receiving, from a central unit-control plane, CU-CP, network node a message identifying a configuration of the CU-UP network node for a Layer 1/Layer 2-triggered mobility, LTM cell switch procedure by a User Equipment, UE. The method also comprises assigning one or more transport network layer, TNL, addresses to one or more LTM candidate target cells for the LTM cell switch procedure.

A further aspect of the present disclosure provides a method performed by a distributed unit, DU, network node. The method comprises receiving, from a central unit-control plane, CU-CP, network node, one or more transport network layer, TNL, addresses that have been assigned to one or more Layer 1/Layer 2-triggered mobility, LTM, candidate target cells of the DU network node.

Another aspect of the present disclosure provides a computer program comprising instructions which, when executed on at least one processor, cause the at least one processor to carry out a method according to any of the above aspects.

Another aspect of the present disclosure provides a central unit-control plane, CU-CP, network node. The CU-CP network node comprises a processor and a memory. The memory contains instructions executable by the processor such that the CU-CP network node is operable to send, to a central unit-user plane, CU-UP, network node a message identifying a configuration of the CU-UP network node for a Layer 1/Layer 2-triggered mobility, LTM, cell switch procedure by a User Equipment, UE.

Another aspect of the present disclosure provides a central unit-user plane, CU-UP, network node. The CU-UP network node comprises a processor and a memory. The memory contains instructions executable by the processor such that the CU-UP network node is operable to receive, from a central unit-control plane, CU-CP, network node a message identifying a configuration of the CU-UP network node for a Layer 1/Layer 2-triggered mobility, LTM cell switch procedure by a User Equipment, UE; and assign one or more transport network layer, TNL, addresses to one or more LTM candidate target cells for the LTM cell switch procedure.

Another aspect of the present disclosure provides a distributed unit, DU, network node. The DU network node comprises a processor and a memory. The memory contains instructions executable by the processor such that the DU network node is operable to receive, from a central unit-control plane, CU-CP, network node, one or more transport network layer, TNL, addresses that have been assigned to one or more Layer 1/Layer 2-triggered mobility, LTM, candidate target cells of the DU network node.

Another aspect of the present disclosure provides a central unit-control plane, CU-CP, network node configured to send, to a central unit-user plane, CU-UP, network node a message identifying a configuration of the CU-UP network node for a Layer 1/Layer 2-triggered mobility, LTM, cell switch procedure by a User Equipment, UE.

Another aspect of the present disclosure provides a central unit-user plane, CU-UP, network node configured to receive, from a central unit-control plane, CU-CP, network node a message identifying a configuration of the CU-UP network node for a Layer 1/Layer 2-triggered mobility, LTM cell switch procedure by a User Equipment, UE; and assign one or more transport network layer, TNL, addresses to one or more LTM candidate target cells for the LTM cell switch procedure.

Another aspect of the present disclosure provides a distributed unit, DU, network node configured to receive, from a central unit-control plane, CU-CP, network node, one or more transport network layer, TNL, addresses that have been assigned to one or more Layer 1/Layer 2-triggered mobility, LTM, candidate target cells of the DU network node.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 is an example of an overall system architecture;

FIG. 2 is a flow chart illustrating a method in accordance with some embodiments;

FIG. 3 is a flow chart illustrating a method in accordance with some embodiments;

FIG. 4 is a flow chart illustrating a method in accordance with some embodiments;

FIG. 5 shows an example of a communication system in accordance with some embodiments;

FIG. 6 shows a UE in accordance with some embodiments;

FIG. 7 shows a network node in accordance with some embodiments;

FIG. 8 is a block diagram of a host;

FIG. 9 is a block diagram illustrating a virtualization environment in which functions implemented by some embodiments may be virtualized; and

FIG. 10 shows a communication diagram of a host communicating via a network node with a UE over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

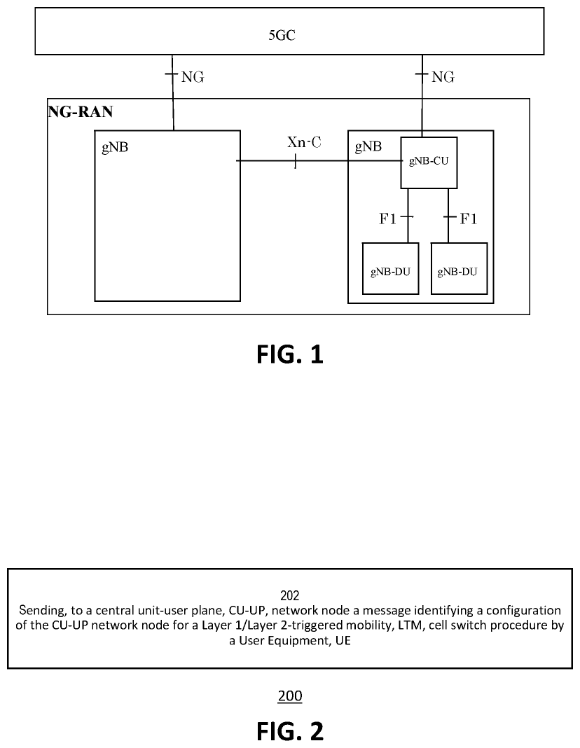

FIG. 1 illustrates an example of an overall system architecture with both Next Generation Radio Access Network (NG-RAN) and 5G Core (5GC), with the NG-RAN split in Central Unit (CU) and Distributed Unit (DU) connected via the F1 interface. The overall architecture comprises a CU and a DU in a Radio Access Network (RAN), in accordance with certain embodiments of the present disclosure. A RAN (as described herein) may correspond to a Next-Generation RAN (NG-RAN), which may be referred to as a 5G RAN. However, the embodiments described herein are applicable to any RAN such as a Sixth Generation (6G) RAN architecture, which may follow a similar split or a different functional split.

The RAN (e.g. NG-RAN) comprises of a set of RAN nodes (e.g. gNBs, 6G gNodeBs) connected to a Core Network (e.g. a 5GC, 6G Core Network) through a RAN/Core Network (CN) interface (e.g. NG interface, S1 interface, 6G NG 1). In the case of NG-RAN, that may comprise one or more ng-eNBs, wherein an ng-eNB may comprises an ng-eNB-CU and one or more ng-eNB-DU(s). A gNB may comprises a gNB-CU and one or more gNB-DU(s). A gNB-CU and a gNB-DU are connected via F1 interface. A gNB-DU may be connected to multiple gNB-CUs by appropriate implementation.

NG, Xn and F1 are logical interfaces. In the case of NG-RAN, the NG and Xn-C interfaces for a gNB comprising a gNB-CU and gNB-DUs terminate in the gNB-CU. For E-UTRA-NR Dual Connectivity (EN-DC), the S1-U and X2-C interfaces for a gNB comprising a gNB-CU and gNB-DUs terminate in the gNB-CU. The gNB-CU and connected gNB-DUs are only visible to other gNBs and the 5GC as a gNB. The terms “Central Entity” and “Distributed Entity” refer to physical network nodes. Thus, when the present disclosure refers to the CU, this is referring to the action(s) being performed by any entities comprised within the CU e.g. CU-CP, gNB-CU-CP.

The present disclosure refers to the term “L1/L2 based inter-cell mobility” as used in the Work Item Description in 3GPP, though it interchangeably also uses the terms L1/L2-triggered mobility (LTM), Lowe layer mobility (LLM), L1/L2 mobility, L1-mobility, L1 based mobility, L1/L2-centric inter-cell mobility or L1/L2 inter-cell mobility. The basic principle is that the UE receives a lower layer signaling from the network indicating to the UE a change (or switch or activation) of its serving cell (e.g. change of Pcell, from a source to a target Pcell), wherein a lower layer signaling is a message/signaling of a lower layer protocol, which may be referred as a L1/L2 inter-cell mobility execution command, or a cell switch command/message. The change of serving cell (e.g. change of Pcell) may also lead to a change in Scell(s) for the same cell group e.g. in case the command triggers the UE to change to another cell group configuration of the same type (e.g. another MCG configuration).

A lower layer protocol refers to a lower layer protocol in the air interface protocol stack compared to RRC protocol, e.g. Medium Access Control (MAC) is considered a lower layer protocol as it is “below” RRC in the air interface protocol stack, and in this case a lower layer signaling/message may correspond to a MAC Control Element (MAC CE). Another example of lower layer protocol is the Layer 1 (or Physical Layer, L1), and in this case a lower layer signaling/message may correspond to a Downlink Control Information (DCI). Signaling information in a protocol layer lower than RRC reduces the processing time and, consequently, reduces the interruption time during mobility; in addition, it may also increase the mobility robustness as the network may respond to faster changes in the channel conditions. Another relevant aspect in L1/L2 inter-cell mobility is that in multi-beam scenario, a cell can be associated to multiple SSBs, and during a half-frame, different SSBs may be transmitted in different spatial directions (i.e. using different beams, spanning the coverage area of a cell). Similar reasoning may be applicable to CSI-RS resources, which may also be transmitted in different spatial directions. Hence, in L1/L2 inter-cell mobility, the reception of a lower layer signaling indicates the UE to change from one beam in the serving cell, to another beam in a neighbour cell (which is a configured candidate cell), and by that changing serving cell (cell switch for LTM).

The phrase “Lower layer signaling indicating to the UE the LTM cell switch procedure” is a message/signal/indication that is sent by the source network node to the UE to provide the UE with the information required for the LTM cell switch procedure. The signaling being ‘lower layer’ means that the signaling is at a layer of the protocol stack below the RRC layer, for example signaling in L1 and/or L2, such as a Medium Access Control Control Element, MAC CE. The UE starts executing the LTM cell switch procedure upon reception of the Lower layer signaling indicating to the UE the LTM cell switch procedure. This does however not exclude that the UE may start executing the LTM cell switch procedure based on other triggers or events.

The present disclosure refers to at least one configuration of a LTM candidate target cell and that the UE is configured with at least one LTM candidate target cell. This configuration may be an RRC configuration, such as encapsulated in an RRC Reconfiguration message, that the UE receives when being configured with inter-DU L1/L2 inter-cell mobility. The configuration of a LTM candidate target cell comprises the configuration which the UE needs to start to operate accordingly when it performs LTM cell switch procedure to that LTM candidate target cell e.g. upon reception of the Lower layer signaling indicating to the UE the LTM cell switch procedure to that LTM candidate target cell, which becomes the target cell and the current (new) SpCell, or an Scell in a serving frequency. The configuration of a LTM candidate target cell comprises parameters of a serving cell (or multiple serving cells, such as a cell group), comprising one or more of the groups of parameters, such as an RRCReconfiguration message an IE CellGroupConfig or an IE SpCellConfig (or the IE ScellConfig, in the case of a Secondary Cell). A configuration of a LTM candidate target cell may in one example comprise one or more of: i) the Pcell configuration and one or more Scell configuration(s) of a Master Cell Group (MCG); i) the PSCell configuration and one or more Scell configuration(s) of a secondary Cell Group (SCG). The terms (LTM) candidate configuration, LTM configuration, (LTM) candidate target cell configuration, (LTM) target candidate (cell) configuration may be used interchangeably when referring to configuration of a LTM candidate target cell.

The phrase LTM cell switch procedure refers to the process of a UE changing its cell from a source cell to a target cell, using L1/L2-triggered mobility. In the context of L1/L2 based inter-cell mobility or L1/L2-triggered mobility (LTM), LTM cell switch procedure may also be known as dynamic switch, LTM switch, (LTM) cell switch, (LTM) serving cell change or (LTM) cell change.

The present disclosure also refers to the term “to handle at least a secondary cell (Scell)” which is when in addition to a primary (secondary) cell (Pcell, PSCell) or Special Cell (SpCell) another cell is configured and this cell is called secondary cell (Scell). This term may also comprise the action of creating (generating) and/or releasing (discarding) and/or change a state of the configuration of a secondary cell. In one example, the UE configures an Scell according to what is received in a LTM candidate target cell configuration and change a “state” of secondary cell to “activate” or “deactivated”.

When the present disclosure indicates that actions are “at execution of a LTM cell switch procedure (also called cell switch for LTM),” this comprises any moment upon reception of the lower layer mobility command for cell switch in LTM execution (e.g. MAC CE indicating a target candidate configuration), such as upon the reception, when the UE applies the lower layer command (e.g. as part of the actions in the UE's MAC entity), or after the UE performs random access to the target cell during the LTM cell switch, or before the UE performs random access to the target cell during the LTM cell switch, or before/after the UE starts monitoring PDCCH (or control channels in general) in the target cell, or before the UE transmits a first UL message to the target cell upon LTM cell switch.

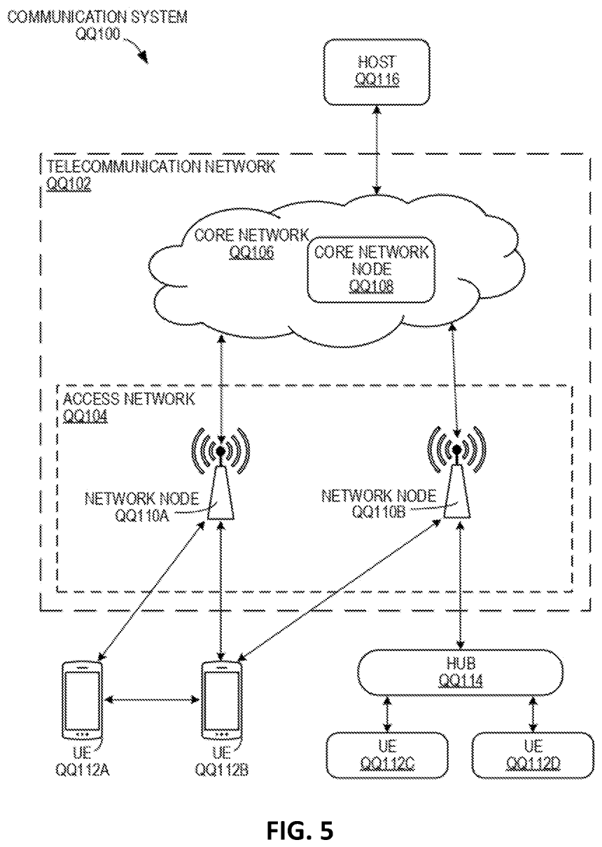

FIG. 2 depicts a method 200 in accordance with particular embodiments. The method 200 may be performed by a network node (e.g. the network node QQ110 or network node QQ300 as described later with reference to FIGS. 5 and 7 respectively), such as a central unit-control plane (CU-CP) network node. The method 200 begins at step 202 with sending, to a central unit-user plane, CU-UP, network node a message identifying a configuration of the CU-UP network node for a Layer 1/Layer 2-triggered mobility, LTM, cell switch procedure by a User Equipment, UE.

In some examples, the method 200 may also comprise sending, to the CU-UP network node, an indication that the LTM cell switch procedure has been executed by the UE. The indication may be sent via E1AP signaling for example.

The method 200 may also in some examples comprise receiving, from the CU-UP network node, one or more transport network layer, TNL, addresses that have been assigned to one or more LTM candidate target cells for the LTM cell switch procedure. The one or more TNL addresses may comprise for example one TNL address, or alternatively may for example be collectively assigned to each of the one or more LTM candidate target cells. The method 200 may also in some examples comprise sending, to the CU-CP network node, a mapping indicating the assignment between the one or more TNL addresses and the one or more LTM candidate target cells. The one or more TNL addresses may be uplink TNL addresses in some examples. In some examples, the method 200 may further comprise receiving, from the CU-UP network node, a status associated with the one or more TNL addresses. The status associated with the one or more TNL addresses may for example indicate that the one or more TNL addresses are not to be used unless indicated otherwise, and/or are only to be used after a UE performs a LTM cell switch procedure to one of the one or more LTM candidate target cells. The method 200 may also in some examples comprise sending, to one of the one or more distributed unit, DU, network nodes, the one or more TNL addresses that have been assigned to the one or more LTM candidate target cells of the DU network node. The one or more TNL addresses may be sent via a F1 interface for example. In some examples, the method 200 may further comprise sending, to the one of the one or more DU network nodes, the status associated with the one or more TNL addresses.

The method 200 may in some examples further comprise sending, to the CU-UP network node, an indication to buffer data packets until a LTM cell switch procedure has been executed by the UE.

The message identifying a configuration of the CU-UP network node may be for example a BEARER CONTEXT SETUP REQUEST or a BEARER CONTEXT MODIFICATION REQUEST. In some examples, the method 200 may comprise, in response to the execution of an LTM cell switch procedure to a target cell that is one of one or more LTM candidate target cells for the LTM cell switch procedure, sending, to the other LTM candidate target cells, one or more of the following non-limiting examples:
an indication that the one or more TNL addresses are not usable;
an indication that an LTM cell switch procedure has been executed and/or completed;
an indication that the one or more TNL addresses should be deleted;
one or more new TNL addresses; and
the TNL address associated with the target cell.

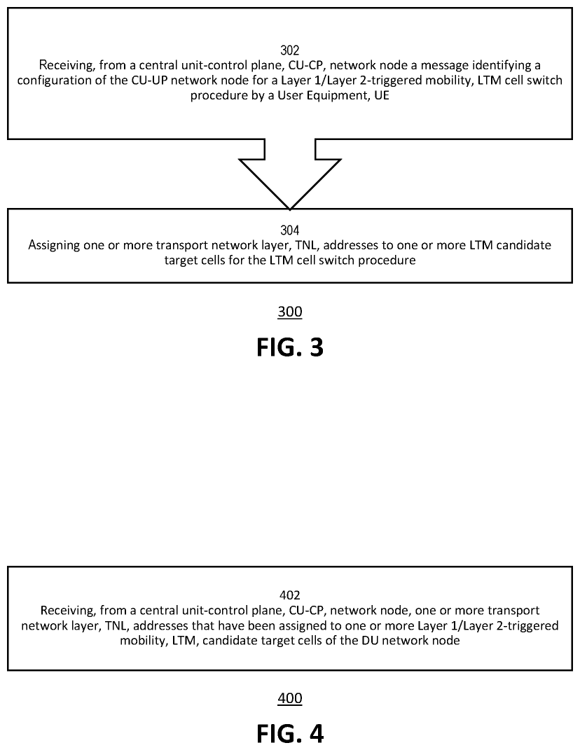

FIG. 3 depicts a method 300 in accordance with particular embodiments. The method 300 may be performed by a network node (e.g. the network node QQ110 or network node QQ300 as described later with reference to FIGS. 5 and 7 respectively), such as a central unit-user plane network node. The method 300 begins at step 302 with receiving, from a central unit-control plane, CU-CP, network node a message identifying a configuration of the CU-UP network node for a Layer 1/Layer 2-triggered mobility, LTM cell switch procedure by a User Equipment, UE. At step 304, the method 300 comprises assigning one or more transport network layer, TNL, addresses to one or more LTM candidate target cells for the LTM cell switch procedure.

In some examples, the method 300 may further comprise sending, to the CU-CP network node, the one or more TNL addresses. The one or more TNL addresses may for example be comprised within a BEARER CONTEXT MODIFICATION RESPONSE message, or a BEARER CONTEXT SETUP RESPONSE message.

The one or more TNL addresses comprise one TNL address in some examples, or may alternatively for example be collectively assigned to each of the one or more LTM candidate target cells. The one or more TNL addresses may be uplink TNL addresses in some examples.

The method 300 may in some examples comprise sending, to the CU-CP network node, a mapping indicating the assignment between the one or more TNL addresses and the one or more LTM candidate target cells. Additionally or alternatively, the method 300 may in some examples comprise receiving, from the CU-UP network node, a status associated with the one or more TNL addresses. The status associated with the one or more TNL addresses may for example indicate that the one or more TNL addresses are not to be used unless indicated otherwise.

In some examples, the method 300 further comprises receiving, from the CU-CP network node, an indication that an LTM cell switch to one of the one or more LTM candidate target cells has been executed. Alternatively, the method 300 may in some examples, comprise receiving, from a distributed unit, DU, network node, a Downlink Data Delivery Service (DDDS) frame indicating an LTM cell switch to one of the one or more LTM candidate target cells has been executed. In either case, the method 300 may in some examples additionally comprise, in response to receiving the indication, forwarding data packets.

FIG. 4 depicts a method 400 in accordance with particular embodiments. The method 400 may be performed by a network node (e.g. the network node QQ110 or network node QQ300 as described later with reference to FIGS. 5 and 7 respectively), such as a distributed unit (DU) network node. The method 400 begins at step 402 with receiving, from a central unit-control plane, CU-CP, network node, one or more transport network layer, TNL, addresses that have been assigned to one or more Layer 1/Layer 2-triggered mobility, LTM, candidate target cells of the DU network node.

In some examples, the method 400 further comprises receiving, from the CU-UP network node, a status associated with the one or more TNL addresses. The one or more transport network layer, TNL, addresses and/or the status may be comprised in some examples within a UE CONTEXT MODIFICATION REQUEST message. In either case, the status associated with the one or more TNL addresses may for example indicate that the one or more TNL addresses are not to be used unless indicated otherwise.

In some examples, the method 400 may further comprise, in response to the execution of an LTM cell switch procedure to a target cell that is one of the one or more LTM candidate target cells, updating the status of the TNL address assigned to the target cell, to indicate that the TNL address is in use. Additionally or alternatively, the method 400 may in some examples comprise, in response to the execution of an LTM cell switch procedure to a target cell that is not one of the one or more LTM candidate target cells, discarding one or more of the TNL addresses, and/or maintaining or updating the status associated with the one or more TNL addresses to indicate that the one or more TNL addresses are not to be used unless indicated otherwise. The method 400 may also in some examples comprise sending, to a central unit-user plane, CU-UP, network node, a Downlink Data Delivery Service (DDDS) frame indicating a LTM cell switch to one of the one or more LTM candidate target cells has been executed.

Further example embodiments performed by a central unit-control plane, CU-CP, network node (also referred to herein as a CU-CP) are set out below. These embodiments are to be read and understood in the context of the method 200 set out with respect to FIG. 2. In addition, further example embodiments performed by a central unit-user plane, CU-UP, network node (also referred to herein as a CU-UP) are set out below. These embodiments are to be read and understood in the context of the method 300 set out with respect to FIG. 3. Furthermore, further example embodiments performed by a distributed unit, DU, network node (also referred to herein as a DU) are set out below. These embodiments are to be read and understood in the context of the method 400 set out with respect to FIG. 4. These example embodiments are provided for illustrative purposes.

In some embodiments, a CU-CP informs a CU-UP that an action involved is an LTM. This method is referred to herein as “A1”. For example, the CU-CP may transmit a BEARER CONTEXT MODIFICATION REQUEST or a BEARER CONTEXT SETUP REQUEST indicating LTM configuration to the CU-UP, or may transmit a new message indicating LTM configuration and/or informing the CU-UP that the action involved is an LTM.

In some embodiments, the CU-CP informs the CU-UP that a Bearer Context Setup or a Bearer Context Modification procedure is triggered by an initial configuration of LTM, and that the new DL GTP-U TEID(s) are not used until the CU-UP is informed that the UE has successfully accessed one of the target cells or early data forwarding is required:
The new UL GTP TEID(s) provided by the CU-UP have to be kept together with old (i.e. already in use for that UE) UL GTP TEID(s) until the first PDCP packet is detected on the new F1-U tunnel(s).
The new configuration (e.g. PDCP configuration, QoS remapping, etc . . . ) will not be applied until the UE successfully access the target cell.

In one embodiment, a Downlink Data Delivery Service (DDDS) frame is received by the CU-UP, indicating that the switch has been performed (that the UE has successfully accessed one of the target cells).

In another embodiment, the CU-CP signals to the CU-UP that the switch happened (that the UE has successfully accessed one of the target cells) via E1AP signaling.

In some embodiments, the CU-CP sends a response of the CU-UP to all the DUs hosting the candidate cells via F1 interface. This method is referred to herein as “A2”.

For example, in some embodiments, the CU-CP forwards UL TNL address(es) received from the CU-UP to the candidate cells under one or more DU(s).

In some embodiments, when the CU-CP forwards the UL TNL address(es) to the candidate cells it may indicate that the status of a certain UL TNL address can be as “deactivated”, or “not used”, or “inactive”, or any other terminology that indicates that that UL TNL address should not be used unless indicated otherwise.

In some embodiments, the CU-CP instructs the CU-UP to withhold packets until LTM execution. This method is referred to herein as “A3”.

For example, in some embodiments, the CU-UP sends an indicator to the CU-UP in the E1AP message, e.g., BEARER CONTEXT MODIFICATION REQUEST.

17herein some embodiments, the CU-CP, after successful completion of LTM (or LTM cell switch procedure), signals to the rest of the candidate cells one or more of the following:
the UL TNL address is not usable anymore because an LTM has been completed and that this UL TNL address should be deleted.
a new UL TNL address to be stored in case an LTM cell switch is triggered.
The UL TNL address that has been “activated” upon the completion of an LTM cell switch. (This is an implicit indication that the UL TNL address with status “activated” cannot be used).
   This method is referred to herein as “A4”.

In some embodiments, the signaling to the rest of the candidate cells may comprise a UE CONTEXT MODIFICATION REQUEST, or may comprise a new message.

In some embodiments, in which the CU-CP (or CU-UP) has pre-configured to the candidate cell more than one UL TNL, in case of an LTM cell switch, if no indication is received by the CU-CP that candidate cell should keep the status of that UL TNL address as “deactivated”, or “not used”, or “inactive”, or any other terminology that indicate that that UL TNL address should not be used.

In some embodiments, the CU-CP, after successful completion of LTM (or a LTM cell switch procedure) restarts the procedure for obtaining a new UL TNL address to be used for LTM according to the embodiments described above. This method is referred to herein as “A5”.

In some embodiments, a CU-UP assigns only a single UL TNL address as a response to being informed by a CU-CP that the action involved is an LTM (for example, in response to receiving a message from the CU-CP informing the CU-UP that the action involved is an LTM). This method is referred to herein as “B1”.

In some embodiments, the CU-CP (or CU-UP) assigns only one UL TNL address and this address is common for all the candidate cell of one or more DU(s).

In some embodiments, the CU-CP (or CU-UP) assigns a list of UL TNL addresses and this list of addresses is common for all the candidate cell of one or more DU(s).

In this example the initial status of all the UL TNL addresses can be “deactivated”, or “not used”, or “inactive”, or any other terminology that indicates that that UL TNL address should not be used (or not used unless indicated otherwise).

In one embodiment, the CU-CP (or CU-UP) assigns a list of UL TNL addresses and this list comprises a mapping about which UL TNL addresses should be assigned to which candidate cell of one or more DU(s).

In some examples the mapping can be eventually decided by the CU-CP (or CU-UP) itself. Also, one UL TNL address may be common to one or more candidate cells.

In some embodiments, a BEARER CONTEXT MODIFICATION RESPONSE may comprise the assigned UL TNL address(es) and/or the list comprising the mapping.

In some embodiments, the CU-UP, as a response to being instructed by the CU-CP to withhold packets until LTM execution, does not forward packets until it receives notification that the execution of LTM is under way. This method is referred to herein as “B2”. This notification in one example can come implicitly when the CU-CP will send DL TEID in a BEARER CONTEXT MODIFICATION REQUEST message

In some embodiments, the CU-UP after receiving the above notification, forwards packets. This method is referred to herein as “B3”.

In some embodiments, one or more Dus receive (following the assignment of the UL TNL address(es), one or more UL TNL address(es) for all candidate cells for LTM. This method is referred to herein as “C1”. In some embodiments, the one or more UL TNL address(es) may be comprised with a UE CONTEXT MODIFICATION REQUEST.

In some embodiments, a DU where the cell that was chosen as target cell for LTM cell switch uses the UL TNL address(es) received above. This method is referred to herein as “C2”.

In some embodiments, the DU where the cell was chosen as target cell for the LTM cell switch changes the status of the UL TNL address to “activate”, or “on”, of “enable”, or any other status that indicate that this UL TNL address is currently used.

In some embodiments, one or more Dus that were not chosen as target cell for LTM cell switch discard the UL TNL address(es) received above. This method is referred to herein as “C3”.

In some embodiments, the DU where the cell was not chosen as target cell for the LTM cell switch change the status of the UL TNL address to “deactivated”, or “not used”, or “off”, or “inactive”, or any other terminology that indicate that that UL TNL address should not be used.

An implementation example is now described for illustrative purposes.

In some embodiments the message in method A1 can be BEARER CONTEXT SETUP REQUEST or BEARER CONTEXT MODIFICATION REQUEST indicating LTM configuration. In one example the message in method A4 can be a UE CONTEXT MODIFICATION REQUEST. In one example the message in method B1 can be BEARER CONTEXT MODIFICATION RESPONSE. In one example the message in method C1 can be UE CONTEXT MODIFICATION REQUEST.

The parts underlined are introduced by this disclosure. The following section is from E1 Application protocol (E1AP).

### 9.2.2.4 Bearer Context Modification Request

This message is sent by the gNB-CU-CP to request the gNB-CU-UP to modify a bearer context.
Direction: gNB-CU-CP→gNB-CU-UP

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.3.1.1 | | YES | reject |
| gNB-CU-CP UE E1AP ID | M | 9.3.1.4 | | YES | reject |
| gNB-CU-UP UE E1AP ID | M | 9.3.1.5 | | YES | reject |
| Security Information | O | 9.3.1.10 | | YES | reject |
| UE DL Aggregate | O | Bit Rate | | YES | reject |
| Maximum Bit Rate | | 9.3.1.20 | | | |
| UE DL Maximum Integrity | O | Bit Rate | The Bit Rate is a | YES | reject |
| Protected Data Rate | | 9.3.1.20 | portion of the UE's | | |
| | | | Maximum Integrity | | |
| | | | Protected Data Rate, | | |
| | | | and is enforced by | | |
| | | | the gNB-CU-UP | | |
| | | | node. | | |
| Bearer Context Status | O | ENUMERATED | Indicates the status | YES | reject |
| Change | | (Suspend, | of the Bearer | | |
| | | Resume, . . . , | Context | | |
| | | ResumeforSDT) | NOTE: This IE is not | | |
| | | | applicable to eNB- | | |
| | | | CP/eNB-UP and ng- | | |
| | | | eNB-CU-CP/ng-eNB- | | |
| | | | CU-UP. | | |
| New UL TNL Information | O | ENUMERATED | Indicates that new | YES | reject |
| Required | | (required, . . . ) | UL TNL information | | |
| | | | has been requested | | |
| | | | to be provided. | | |
| UE Inactivity Timer | O | Inactivity Timer | Included if the | — | — |
| | | 9.3.1.54 | Activity Notification | | |
| | | | Level is set to UE. | | |
| Data Discard Required | O | ENUMERATED | Indicate to discard | YES | ignore |
| | | (required, . . . ) | the DL user data in | | |
| | | | case of RAN paging | | |
| | | | failure. | | |
| CHOICE System | O | | | YES | reject |
| >E-UTRAN | | | | | |
| >>DRB To Setup List | O | DRB To Setup | | YES | reject |
| | | Modification List | | | |
| | | E-UTRAN | | | |
| | | 9.3.3.7 | | | |
| >>DRB To Modify List | O | DRB To Modify | | YES | reject |
| | | List E-UTRAN | | | |
| | | 9.3.3.8 | | | |
| >>DRB To Remove | O | DRB To | | YES | reject |
| List | | Remove List E- | | | |
| | | UTRAN | | | |
| | | 9.3.3.9 | | | |
| >>Subscriber Profile ID | O | 9.3.1.69 | | YES | ignore |
| for RAT/Frequency | | | | | |
| priority | | | | | |
| >>Additional RRM | O | 9.3.1.70 | | YES | ignore |
| Policy Index | | | | | |
| >NG-RAN | | | | | |
| >>PDU Session | O | PDU Session | | YES | reject |
| Resource To Setup List | | Resource To | | | |
| | | Setup | | | |
| | | Modification List | | | |
| | | 9.3.3.10 | | | |
| >>PDU Session | O | 9.3.3.11 | | YES | reject |
| Resource To Modify | | | | | |
| List | | | | | |
| >>PDU Session | O | 9.3.3.12 | | YES | reject |
| Resource To Remove | | | | | |
| List | | | | | |
| RAN UE ID | O | OCTET STRING | | YES | ignore |
| | | (SIZE(8)) | | | |
| gNB-DU ID | O | 9.3.1.65 | | YES | ignore |
| Activity Notification Level | O | 9.3.1.67 | | YES | ignore |
| MDT Polluted | O | ENUMERATED | Indication on | YES | ignore |
| Measurement Indicator | | (IDC, no-IDC, | whether MDT | | |
| | | . . . ) | Measurement affect | | |
| | | | (e.g. IDC) is | | |
| | | | undertake or not. | | |
| UE Slice Maximum Bit | O | 9.3.1.102 | | YES | ignore |
| Rate List | | | | | |
| SCG Activation Status | O | 9.3.1.105 | | YES | ignore |
| SDT Continue ROHC | O | ENUMERATED | Indicates ROHC | YES | reject |
| | | (true, . . . ) | should be continued | | |
| | | | for SDT DRBs. See | | |
| | | | description of sdt- | | |
| | | | DRB- | | |
| | | | ContinueROHC-r17 | | |
| | | | in TS 38.331 [10]. | | |
| Management Based MDT | O | MDT PLMN | | YES | ignore |
| PLMN Modification List | | Modification | | | |
| | | List | | | |
| | | 9.3.1.129 | | | |
| LTM information | | | Details FFS. For | | |
| | | | example, an | | |
| | | | indicator with | | |
| | | | Enumerated value. | | |

| Range bound | Explanation |
|---|---|
| maxnoofDRBs | Maximum no. of DRBs for a UE. Value is |
| | 32. |
| maxnoofPDUSessionResource | Maximum no. of PDU Sessions for a UE. |
| | Value is 256. |

The following example is from F1 Application protocol (F1AP).

### 9.2.2.7 UE Context Modification Request

This message is sent by the gNB-CU to provide UE Context information changes to the gNB-DU.
Direction: gNB-CU→gNB-DU

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| gNB-CU UE F1AP ID | M | | 9.3.1.4 | | YES | reject |
| gNB-DU UE F1AP ID | M | | 9.3.1.5 | | YES | reject |
| SpCell ID | O | | NR CGI | Special Cell as | YES | ignore |
| | | | 9.3.1.12 | defined in TS 38.321 | | |
| | | | | [16]. For handover | | |
| | | | | case, this IE is | | |
| | | | | considered as target | | |
| | | | | cell. | | |
| ServCellIndex | O | | INTEGER | | YES | reject |
| | | | (0 . . . 31, . . . ) | | | |
| SpCell UL Configured | O | | Cell UL | | YES | ignore |
| | | | Configured | | | |
| | | | 9.3.1.33 | | | |
| DRX Cycle | O | | DRX Cycle | | YES | ignore |
| | | | 9.3.1.24 | | | |
| CU to DU RRC | O | | 9.3.1.25 | | YES | reject |
| Information | | | | | | |
| Transmission Action | O | | 9.3.1.11 | | YES | ignore |
| Indicator | | | | | | |
| Resource Coordination | O | | OCTET | Includes the MeNB | YES | ignore |
| Transfer Container | | | STRING | Resource | | |
| | | | | Coordination | | |
| | | | | Information IE as | | |
| | | | | defined in subclause | | |
| | | | | 9.2.116 of TS 36.423 | | |
| | | | | [9] for EN-DC case or | | |
| | | | | MR-DC Resource | | |
| | | | | Coordination | | |
| | | | | Information IE as | | |
| | | | | defined in TS 38.423 | | |
| | | | | [28] for NGEN-DC | | |
| | | | | and NE-DC cases. | | |
| RRC Reconfiguration | O | | 9.3.1.30 | | YES | ignore |
| Complete Indicator | | | | | | |
| RRC-Container | O | | 9.3.1.6 | Includes the DL- | YES | reject |
| | | | | DCCH-Message IE as | | |
| | | | | defined in subclause | | |
| | | | | 6.2 of TS 38.331 [8], | | |
| | | | | encapsulated in a | | |
| | | | | PDCP PDU. | | |
| SCell To Be Setup | | 0 . . . 1 | | | YES | ignore |
| List | | | | | | |
| >SCell to Be Setup | | 1 . . . | | | EACH | ignore |
| Item IEs | | <maxnoofSCells> | | | | |
| >>SCell ID | M | | NR CGI | SCell Identifier in gNB | — | |
| | | | 9.3.1.12 | | | |
| >>SCellIndex | M | | INTEGER | | — | |
| | | | (1 . . . 31) | | | |
| >>SCell UL | O | | Cell UL | | — | |
| Configured | | | Configured | | | |
| | | | 9.3.1.33 | | | |
| >>servingCellMO | O | | INTEGER | | YES | ignore |
| | | | (1 . . . 64) | | | |
| SCell To Be Removed | | 0 . . . 1 | | | YES | ignore |
| List | | | | | | |
| >SCell to Be | | 1 . . . | | | EACH | ignore |
| Removed Item IEs | | <maxnoofSCells> | | | | |
| >>SCell ID | M | | NR CGI | SCell Identifier in gNB | — | |
| | | | 9.3.1.12 | | | |
| SRB to Be Setup List | | 0 . . . 1 | | | YES | reject |
| >SRB to Be Setup | | 1 . . . <maxnoofSRBs> | | | EACH | reject |
| Item IEs | | | | | | |
| >>SRB ID | M | | 9.3.1.7 | | — | |
| >>Duplication | O | | ENUMERATED | This IE is ignored if | — | |
| Indication | | | (true, . . . , | the Additional | | |
| | | | false) | Duplication Indication | | |
| | | | | IE is present. | | |
| >>Additional | O | | ENUMERATED | | YES | ignore |
| Duplication | | | (three, | | | |
| Indication | | | four, . . . ) | | | |
| >>SRB Mapping Info | O | | Uu RLC | This IE contains the | YES | ignore |
| | | | Channel ID | mapped Uu Relay | | |
| | | | 9.3.1.266 | RLC CH ID for the | | |
| | | | | SRB | | |
| >>SDT Indicator | O | | ENUMERATED | Indicates SDT SRB. | YES | reject |
| Setup | | | (true, . . . ) | | | |
| DRB to Be Setup List | | 0 . . . 1 | | | YES | reject |
| >DRB to Be Setup | | 1 . . . | | | EACH | reject |
| Item IEs | | <maxnoofDRBs> | | | | |
| >>DRB ID | M | | 9.3.1.8 | | — | |
| >>CHOICE QoS | M | | | | — | |
| Information | | | | | | |
| >>>E-UTRAN QoS | | | | | | |
| >>>>E-UTRAN | M | | 9.3.1.19 | Shall be used for EN- | | |
| QoS | | | | DC case to convey E- | | |
| | | | | RAB Level QoS | | |
| | | | | Parameters | | |
| >>>DRB | | | | | | |
| Information | | | | | | |
| >>>>DRB | | 1 | | Shall be used for NG- | YES | ignore |
| Information | | | | RAN cases | | |
| >>>>>DRB QoS | M | | 9.3.1.45 | | — | |
| >>>>>S-NSSAI | M | | 9.3.1.38 | | — | |
| >>>>>Notification | O | | 9.3.1.56 | | — | |
| Control | | | | | | |
| >>>>>Flows | | 1 . . . | | | — | |
| Mapped to DRB | | <maxnoofQoSFlows> | | | | |
| Item | | | | | | |
| >>>>>>QoS | M | | 9.3.1.63 | | — | |
| Flow Identifier | | | | | | |
| >>>>>>QoS | M | | 9.3.1.45 | | — | |
| Flow Level QoS | | | | | | |
| Parameters | | | | | | |
| >>>>>>QoS | O | | 9.3.1.72 | | YES | ignore |
| Flow Mapping | | | | | | |
| Indication | | | | | | |
| >>>>>>TSC | O | | 9.3.1.141 | Traffic pattern | YES | ignore |
| Traffic | | | | information | | |
| Characteristics | | | | associated with the | | |
| | | | | QFI. Details in TS | | |
| | | | | 23.501 [21]. | | |
| >>UL UP TNL | | 1 | | | — | |
| Information to be | | | | | | |
| setup List | | | | | | |
| >>>UL UP TNL | | 1 . . . | | | — | |
| Information to Be | | <maxnoofULUPTNLInformation> | | | | |
| Setup Item IEs | | | | | | |
| >>>>UL UP TNL | M | | UP | gNB-CU endpoint of | — | |
| Information | | | Transport | the F1 transport | | |
| | | | Layer | bearer. For delivery of | | |
| | | | Information | UL PDUs. | | |
| | | | 9.3.2.1 | | | |
| >>>>UL UP TNL | | | ENUMERATED | In case of LTM, this | | |
| Information | | | (release, . . . ,) | IE indicates if the UL | | |
| Indication | | | | UP TNL Information | | |
| | | | | should be removed | | |
| >>>>BH | O | | 9.3.1.114 | | YES | ignore |
| Information | | | | | | |
| >>>>DRB | O | | Uu RLC | This IE contains the | YES | ignore |
| Mapping Info | | | Channel ID | mapped Uu Relay | | |
| | | | 9.3.1.266 | RLC CH ID of the DL | | |
| | | | | tunnel corresponding | | |
| | | | | to such UL tunnel | | |
| >>RLC Mode | M | | 9.3.1.27 | | — | |
| >>UL Configuration | O | | UL | Information about UL | — | |
| | | | Configuration | usage in gNB-DU. | | |
| | | | 9.3.1.31 | | | |
| >>Duplication | O | | 9.3.1.36 | Information on the | — | |
| Activation | | | | initial state of CA | | |
| | | | | based UL PDCP | | |
| | | | | duplication. | | |
| | | | | This IE is ignored if | | |
| | | | | the RLC Duplication | | |
| | | | | Information IE is | | |
| | | | | present. | | |
| >>DC Based | O | | ENUMERATED | Indication on whether | YES | reject |
| Duplication | | | (true, . . . , | DC based PDCP | | |
| Configured | | | false) | duplication is | | |
| | | | | configured or not. If | | |
| | | | | included, it should be | | |
| | | | | set to true. | | |
| >>DC Based | O | | Duplication | Information on the | YES | reject |
| Duplication | | | Activation | initial state of DC | | |
| Activation | | | 9.3.1.36 | based UL PDCP | | |
| | | | | duplication. | | |
| | | | | This IE is ignored if | | |
| | | | | the RLC Duplication | | |
| | | | | Information IE is | | |
| | | | | present. | | |
| >>DL PDCP SN | O | | ENUMERATED | | YES | ignore |
| length | | | (12bits, | | | |
| | | | 18bits, . . . ) | | | |
| >>UL PDCP SN | O | | ENUMERATED | | YES | ignore |
| length | | | (12bits, | | | |
| | | | 18bits, . . . ) | | | |
| >>Additional PDCP | | 0 . . . 1 | | | YES | ignore |
| Duplication TNL | | | | | | |
| List | | | | | | |
| >>>Additional | | 1 . . . | | | EACH | ignore |
| PDCP Duplication | | <maxnoofAddition- | | | | |
| TNL Items | | aIPDCPDuplicationTNL> | | | | |
| >>>>Additional | M | | UP | gNB-CU endpoint of | — | |
| PDCP Duplication | | | Transport | the F1 transport | | |
| UP TNL | | | Layer | bearer. For delivery of | | |
| Information | | | Information | UL PDUs. | | |
| | | | 9.3.2.1 | | | |
| >>>>BH | O | | 9.3.1.114 | | YES | ignore |
| Information | | | | | | |
| >>RLC Duplication | O | | 9.3.1.146 | | YES | ignore |
| Information | | | | | | |
| >>SDT Indicator | O | | ENUMERATED | Indicates SDT DRB. | YES | reject |
| Setup | | | (true, . . . ) | | | |
| DRB to Be Modified | | 0 . . . 1 | | | YES | reject |
| List | | | | | | |
| >DRB to Be Modified | | 1 . . . | | | EACH | reject |
| Item IEs | | <maxnoofDRBs> | | | | |
| >>DRB ID | M | | 9.3.1.8 | | — | |
| >>CHOICE QoS | O | | | | — | |
| Information | | | | | | |
| >>>E-UTRAN QoS | | | | | | |
| >>>E-UTRAN QoS | M | | 9.3.1.19 | Used for EN-DC case | — | |
| | | | | to convey E-RAB | | |
| | | | | Level QoS | | |
| | | | | Parameters | | |
| >>>DRB | | | | | | |
| Information | | | | | | |
| >>>>DRB | | 1 | | Used for NG-RAN | YES | ignore |
| Information | | | | cases | | |
| >>>>>DRB QoS | M | | 9.3.1.45 | | — | |
| >>>>>S-NSSAI | M | | 9.3.1.38 | | — | |
| >>>>>Notification | O | | 9.3.1.56 | | — | |
| Control | | | | | | |
| >>>>>Flows | | 1 . . . | | | — | |
| Mapped to DRB | | <maxnoofQoSFlows> | | | | |
| Item | | | | | | |
| >>>>>>QoS | M | | 9.3.1.63 | | — | |
| Flow Identifier | | | | | | |
| >>>>>>QoS | M | | 9.3.1.45 | | — | |
| Flow Level QoS | | | | | | |
| Parameters | | | | | | |
| >>>>>>QoS | O | | 9.3.1.72 | | YES | ignore |
| Flow Mapping | | | | | | |
| Indication | | | | | | |
| >>>>>>TSC | O | | 9.3.1.141 | Traffic pattern | YES | ignore |
| Traffic | | | | information | | |
| Characteristics | | | | associated with the | | |
| | | | | QFI. Details in TS | | |
| | | | | 23.501 [21]. | | |
| >>UL UP TNL | | 1 | | | — | |
| Information to be | | | | | | |
| setup List | | | | | | |
| >>>UL UP TNL | | 1 . . . | | | — | |
| Information to Be | | <maxnoofULUPTNLInformation> | | | | |
| Setup Item IEs | | | | | | |
| >>>>UL UP TNL | M | | UP | gNB-CU endpoint of | — | |
| Information | | | Transport | the F1 transport | | |
| | | | Layer | bearer. For delivery of | | |
| | | | Information | UL PDUs. | | |
| | | | 9.3.2.1 | | | |
| >>>>UL UP TNL | | | ENUMERATED | In case of LTM, this | | ignore |
| Information | | | (release, . . . ,) | IE indicates if the UL | | |
| Indication | | | | UP TNL Information | | |
| | | | | should be removed | | |
| >>>>DRB | O | | Uu RLC | | YES | ignore |
| Mapping Info | | | Channel ID | | | |
| | | | 9.3.1.266 | | | |
| >>UL Configuration | O | | UL | Information about UL | — | |
| | | | Configuration | usage in gNB-DU. | | |
| | | | 9.3.1.31 | | | |
| >>DL PDCP SN | O | | ENUMERATED | | YES | ignore |
| length | | | (12bits, 18 | | | |
| | | | bits, . . . ) | | | |
| >>UL PDCP SN | O | | ENUMERATED | | YES | ignore |
| length | | | (12bits, | | | |
| | | | 18bits, . . . ) | | | |
| >>Bearer Type | O | | ENUMERATED | | YES | ignore |
| Change | | | (true, . . . ) | | | |
| >>RLC Mode | O | | 9.3.1.27 | | YES | ignore |
| >>Duplication | O | | 9.3.1.36 | Information on the | YES | reject |
| Activation | | | | initial state of CA | | |
| | | | | based UL PDCP | | |
| | | | | duplication. | | |
| | | | | This IE is ignored if | | |
| | | | | the RLC Duplication | | |
| | | | | Information IE is | | |
| | | | | present. | | |
| >>DC Based | O | | ENUMERATED | Indication on whether | YES | reject |
| Duplication | | | (true, . . . , | DC based PDCP | | |
| Configured | | | false) | duplication is | | |
| | | | | configured or not. | | |
| >>DC Based | O | | 9.3.1.36 | Information on the | YES | reject |
| Duplication | | | | initial state of DC | | |
| Activation | | | | based UL PDCP | | |
| | | | | duplication. | | |
| | | | | This IE is ignored if | | |
| | | | | the RLC Duplication | | |
| | | | | Information IE is | | |
| | | | | present. | | |
| >>Additional PDCP | | 0 . . . 1 | | | YES | ignore |
| Duplication TNL | | | | | | |
| List | | | | | | |
| >>>Additional | | 1 . . . | | | EACH | ignore |
| PDCP Duplication | | <maxnoofAddition- | | | | |
| TNL Items | | alPDCPDuplicationTNL> | | | | |
| >>>>Additional | M | | UP | gNB-CU endpoint of | — | |
| PDCP Duplication | | | Transport | the F1 transport | | |
| UP TNL | | | Layer | bearer. For delivery of | | |
| Information | | | Information | UL PDUs. | | |
| | | | 9.3.2.1 | | | |
| >>>>BH | O | | 9.3.1.114 | | YES | ignore |
| Information | | | | | | |
| >>RLC Duplication | O | | 9.3.1.146 | | YES | ignore |
| Information | | | | | | |
| >>Transmission Stop | O | | 9.3.1.209 | | YES | ignore |
| Indicator | | | | | | |
| >>SDT Indicator | O | | ENUMTERATED | Indicates SDT DRB or | YES | reject |
| Modify | | | (true, | not. | | |
| | | | false, . . . ) | | | |
| SRB To Be Released | | 0 . . . 1 | | | YES | reject |
| List | | | | | | |
| >SRB To Be | | 1 . . . | | | EACH | reject |
| Released Item IEs | | <maxnoofSRBs> | | | | |
| >>SRB ID | M | | 9.3.1.7 | | | |
| DRB to Be Released | | 0 . . . 1 | | | YES | reject |
| List | | | | | | |
| >DRB to Be | | 1 . . . | | | EACH | reject |
| Released Item IEs | | <maxnoofDRBs> | | | | |
| >>DRB ID | M | | 9.3.1.8 | | — | |
| Inactivity Monitoring | O | | ENUMERATED | | YES | reject |
| Request | | | (true, . . . ) | | | |
| RAT-Frequency Priority | O | | 9.3.1.34 | | YES | reject |
| Information | | | | | | |
| DRX configuration | O | | ENUMERATED | | YES | ignore |
| indicator | | | (release, . . . ) | | | |
| RLC Failure Indication | O | | 9.3.1.66 | | YES | ignore |
| Uplink | O | | 9.3.1.67 | | YES | ignore |
| TxDirectCurrentList | | | | | | |
| Information | | | | | | |
| GNB-DU Configuration | O | | ENUMERATED | Used to request the | YES | reject |
| Query | | | (true, . . . ) | gNB-DU to provide its | | |
| | | | | configuration. | | |
| gNB-DU UE Aggregate | O | | Bit Rate | The gNB-DU UE | YES | ignore |
| Maximum Bit Rate | | | 9.3.1.22 | Aggregate Maximum | | |
| Uplink | | | | Bit Rate Uplink is to | | |
| | | | | be enforced by the | | |
| | | | | gNB-DU. | | |
| Execute Duplication | O | | ENUMERATED | This IE may be sent | YES | ignore |
| | | | (true, . . . ) | only if duplication has | | |
| | | | | been configured for | | |
| | | | | the UE. | | |
| RRC Delivery Status | O | | ENUMERATED | Indicates whether | YES | ignore |
| Request | | | (true, . . . ) | RRC DELIVERY | | |
| | | | | REPORT procedure | | |
| | | | | is requested for the | | |
| | | | | RRC message. | | |
| Resource Coordination | O | | 9.3.1.73 | | YES | ignore |
| Transfer Information | | | | | | |
| servingCellMO | O | | INTEGER | | YES | ignore |
| | | | (1 . . . 64, . . . ) | | | |
| Need for Gap | O | | ENUMERATED | Indicate gap for SeNB | Yes | ignore |
| | | | (true, . . . ) | configured | | |
| | | | | measurement is | | |
| | | | | requested. It only | | |
| | | | | applied to NE DC | | |
| | | | | scenario. | | |
| Full Configuration | O | | ENUMERATED | | YES | reject |
| | | | (full, . . . ) | | | |
| Additional RRM Policy | O | | 9.3.1.90 | | YES | ignore |
| Index | | | | | | |
| Lower Layer Presence | O | | 9.3.1.94 | | Yes | ignore |
| Status Change | | | | | | |
| . . . rows omitted | | | | | | |
| Conditional Intra-DU | O | | | | YES | reject |
| Mobility Information | | | | | | |
| >CHO Trigger | M | | ENUMERATED | | — | — |
| | | | (CHO- | | | |
| | | | initiation, | | | |
| | | | CHO- | | | |
| | | | replace, | | | |
| | | | CHO-cancel, | | | |
| | | | . . . ) | | | |
| >Candidate Cells To | C- | 0 . . . | | | — | — |
| Be Cancelled List | ifCHOcancel | <maxnoofCellsinCHO> | | | | |
| >>Target Cell ID | M | | NR CGI | | — | — |
| | | | 9.3.1.12 | | | |
| Rows omitted | | | | | | |

FIG. 5 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 5 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 5, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, a content source and analytics node, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

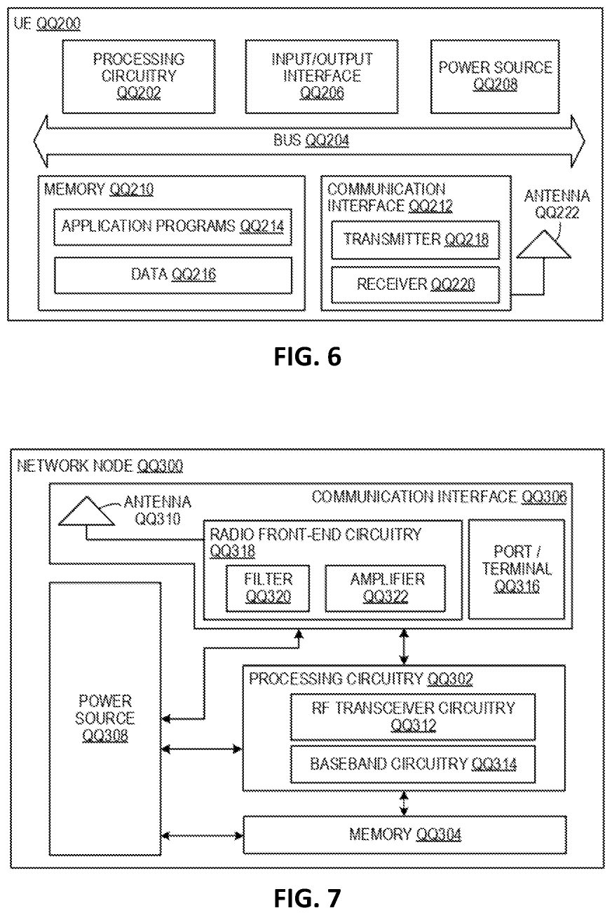

FIG. 6 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs). The processing circuitry QQ202 may be operable to provide, either alone or in conjunction with other UE QQ200 components, such as the memory QQ210, UE QQ200 functionality.

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In some embodiments, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE QQ200 shown in FIG. 6.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 7 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU). In some embodiments, the network node QQ300 may be a central unit-control plane network node, a central unit-user plane network node, or a distributed network node.

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes processing circuitry QQ302, a memory QQ304, a communication interface QQ306, and a power source QQ308, and/or any other component, or any combination thereof. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, network node QQ300 functionality. For example, the processing circuitry QQ302 may be configured to cause the network node to perform the methods as described with reference to any of FIGS. 2-4.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 7 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

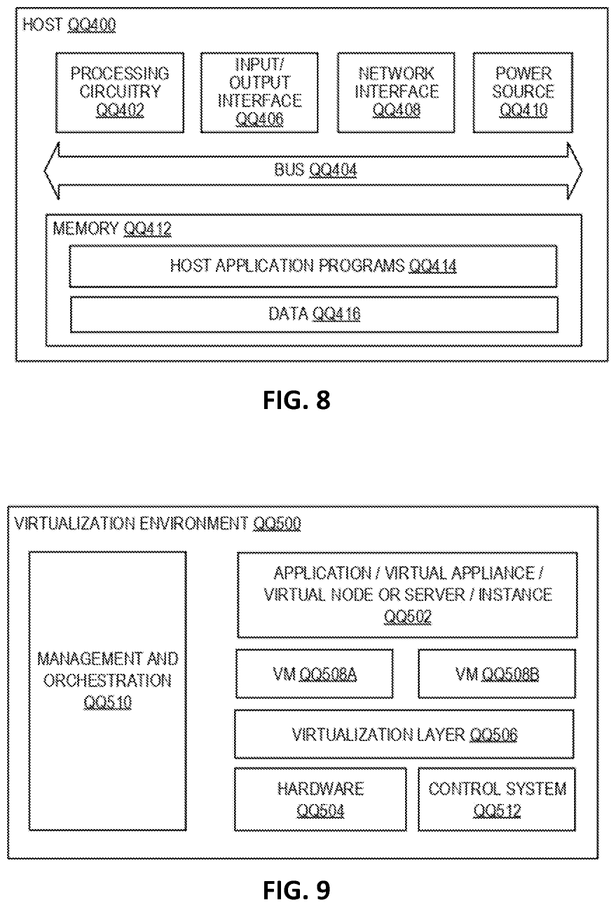

FIG. 8 is a block diagram of a host QQ400, which may be an embodiment of the host QQ116 of FIG. 5, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 6 and 7, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 9 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

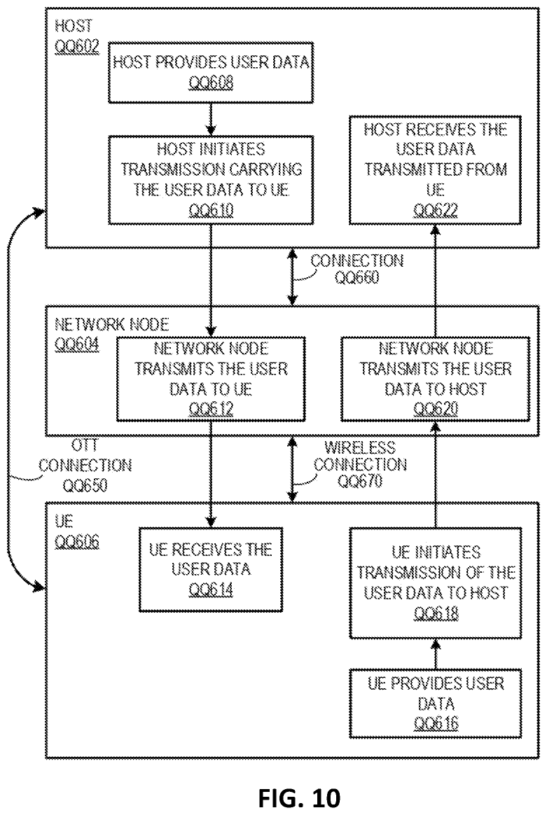

FIG. 10 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 5 and/or UE QQ200 of FIG. 6), network node (such as network node QQ110a of FIG. 5 and/or network node QQ300 of FIG. 7), and host (such as host QQ116 of FIG. 5 and/or host QQ400 of FIG. 8) discussed in the preceding paragraphs will now be described with reference to FIG. 10.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 5) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UEs client application may receive request data from the host's host application and provide user data in response to the request data. The OTT connection QQ650 may transfer both the request data and the user data. The UEs client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the latency thereby provide benefits such as reduced user waiting time.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

This disclosure includes the following enumerated embodiments.

### Group A Embodiments

1. A method performed by a central unit-control plane, CU-CP, network node, the method comprising:
   sending, to a central unit-user plane, CU-UP, network node a message identifying a configuration of the CU-UP network node for a Layer 1/Layer 2-triggered mobility, LTM cell switch procedure by a User Equipment, UE.
2. The method of embodiment 1, further comprising:
   sending, to the CU-UP network node, an indication that an LTM cell switch to one of the one or more LTM candidate target cells has been executed.
3. The method of embodiment 2, wherein the indication is sent via E1AP signaling.
4. The method of any preceding embodiment, further comprising:
   receiving, from the CU-UP network node, one or more transport network layer, TNL, addresses that have been assigned to the one or more LTM candidate target cells.
5. The method of embodiment 4, wherein the one or more TNL addresses comprise one TNL address.
6. The method of embodiment 4, wherein the one or more TNL addresses are collectively assigned to each of the one or more LTM candidate target cells.
7. The method of any of embodiments 4-6, further comprising sending, to the CU-CP network node, a mapping indicating the assignment between the one or more TNL addresses and the one or more LTM candidate target cells.
8. The method of any of embodiments 4-7, wherein the one or more TNL addresses are uplink TNL addresses.
9. The method of any of embodiments 4-8, the method further comprising:
   receiving, from the CU-UP network node, a status associated with the one or more TNL addresses.
10. The method of embodiment 9, wherein the status associated with the one or more TNL addresses indicates that the one or more TNL addresses are not to be used unless indicated otherwise, and/or are only to be used after a UE performs a LTM cell switch procedure to one of the one or more LTM candidate target cells.
11. The method of any of embodiments 4-10, further comprising:
   sending, to one of the one or more distributed unit, DU, network nodes, the one or more TNL addresses that have been assigned to the one or more LTM candidate target cells of the DU network node.
12. The method of embodiment 11, wherein the one or more TNL addresses are sent via a F1 interface.
13. The method of embodiment 11 or 12, when dependent on embodiment 9 or 10, further comprising:
   sending, to the one of the one or more DU network nodes, the status associated with the one or more TNL addresses.
14. The method of any preceding embodiment, further comprising:
   sending, to the CU-UP network node, an indication to buffer data packets until a LTM cell switch procedure to one of the one or more LTM candidate target cells has been executed.
15. The method of any preceding embodiment, wherein the message identifying a configuration of the CU-UP network node comprises a BEARER CONTEXT SETUP REQUEST or a BEARER CONTEXT MODIFICATION REQUEST.
16. The method of any preceding embodiment, further comprising:
   in response to the execution of an LTM cell switch procedure to a target cell that is one of the one or more LTM candidate target cells, sending, to the other LTM candidate target cells, one or more of:
   an indication that the one or more TNL addresses are not usable;
   an indication that an LTM cell switch procedure has been executed and/or completed;
   an indication that the one or more TNL addresses should be deleted;
   one or more new TNL addresses; and
   the TNL address associated with the target cell.
17. The method of any of the previous embodiments, further comprising:
   obtaining user data; and
   forwarding the user data to a host or a user equipment.

### Group B Embodiments

18. A method performed by a central unit-user plane, CU-UP, network node, the method comprising:
   receiving, from a central unit-control plane, CU-CP, network node a message identifying a configuration of the CU-UP network node for a Layer 1/Layer 2-triggered mobility, LTM cell switch procedure by a User Equipment, UE; and
   assigning one or more transport network layer, TNL, addresses to the one or more LTM candidate target cells.
19. The method of embodiment 18, further comprising:
   sending, to the CU-CP network node, the one or more TNL addresses.
20. The method of embodiment 19, wherein the one or more TNL addresses are comprised within a BEARER CONTEXT MODIFICATION RESPONSE message, or a BEARER CONTEXT SETUP RESPONSE message.
21. The method of any of embodiments 18-20, wherein the one or more TNL addresses comprise one TNL address.
22. The method of any of embodiments 18-20, wherein the one or more TNL addresses are collectively assigned to each of the one or more LTM candidate target cells.
23. The method of any of embodiments 18-22, further comprising:
   sending, to the CU-CP network node, a mapping indicating the assignment between the one or more TNL addresses and the one or more LTM candidate target cells.
24. The method of any of embodiments 18-23, wherein the one or more TNL addresses are uplink TNL addresses.
25. The method of any of embodiments 18-24, the method further comprising: receiving, from the CU-UP network node, a status associated with the one or more TNL addresses.
26. The method of embodiment 25, wherein the status associated with the one or more TNL addresses indicates that the one or more TNL addresses are not to be used unless indicated otherwise.
27. The method of any of embodiments 18-26, the method further comprising: receiving, from the CU-CP network node, an indication that an LTM cell switch to one of the one or more LTM candidate target cells has been executed.
28. The method of any of embodiments 18-26, the method further comprising:
   receiving, from a distributed unit, DU, network node, a Downlink Data Delivery Service (DDDS) frame indicating an LTM cell switch to one of the one or more LTM candidate target cells has been executed.
29. The method of embodiment 27 or 28, the method further comprising:
   in response to receiving the indication, forwarding data packets.
30. The method of any of embodiments, further comprising:
   obtaining user data; and
   forwarding the user data to a host or a user equipment.

### Group C Embodiments

31. A method performed by a distributed unit, DU, network node the method comprising:
   receiving, from a central unit-control plane, CU-CP, network node one or more transport network layer, TNL, addresses that have been assigned to one or more Layer 1/Layer 2-triggered mobility, LTM, candidate target cells of the DU network node.
32. The method of embodiment 31, the method further comprising:
   receiving, from the CU-UP network node, a status associated with the one or more TNL addresses.
33. The method of embodiment 31 or 32, wherein the one or more transport network layer, TNL, addresses and/or the status are comprised within a UE CONTEXT MODIFICATION REQUEST message
34. The method of embodiment 32 or 33, wherein the status associated with the one or more TNL addresses indicates that the one or more TNL addresses are not to be used unless indicated otherwise.
35. The method of any of embodiments 31-34, wherein, in response to the execution of an LTM cell switch procedure to a target cell that is one of the one or more LTM candidate target cells, the method further comprises:
   updating the status of the TNL address assigned to the target cell, to indicate that the TNL address is in use.
36. The method of any of embodiments 31-35, wherein, in response to the execution of an LTM cell switch procedure to a target cell that is not one of the one or more LTM candidate target cells, the method further comprises one or more of:
   discarding one or more of the TNL addresses;
   maintaining or updating the status associated with the one or more TNL addresses to indicate that the one or more TNL addresses are not to be used unless indicated otherwise.
37. The method of any of embodiments 31-36, further comprising:
   sending, to a central unit-user plane, CU-UP, network node, a Downlink Data Delivery Service (DDDS) frame indicating a LTM cell switch to one of the one or more LTM candidate target cells has been executed.
38. The method of any of the previous embodiments, further comprising:
   obtaining user data; and
   forwarding the user data to a host or a user equipment.

### Group D Embodiments

39. A network node, the network node comprising:
   processing circuitry configured to cause the network node to perform any of the steps of any of the Group A-C embodiments;
   power supply circuitry configured to supply power to the processing circuitry.
40. A network node, the network node comprising:
   processing circuitry configured to cause the network node to perform any of the steps of any of the Group A-C embodiments;
   power supply circuitry configured to supply power to the processing circuitry.
41. A network node, the network node comprising:
   processing circuitry configured to cause the network node to perform any of the steps of any of the Group A-C embodiments;
   power supply circuitry configured to supply power to the processing circuitry.
42. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group A-C embodiments to transmit the user data from the host to the UE.
43. The host of the previous embodiment, wherein:
   the processing circuitry of the host is configured to execute a host application that provides the user data; and
   the UE comprises processing circuitry configured to execute a client application associated with the host application to receive the transmission of user data from the host.
44. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group A-C embodiments to transmit the user data from the host to the UE.
45. The method of the previous embodiment, further comprising, at the network node, transmitting the user data provided by the host for the UE.
46. The method of any of the previous 2 embodiments, wherein the user data is provided at the host by executing a host application that interacts with a client application executing on the UE, the client application being associated with the host application.
47. A communication system configured to provide an over-the-top (OTT) service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group A-C embodiments to transmit the user data from the host to the UE.
48. The communication system of the previous embodiment, further comprising: the network node; and/or the UE.
49. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group A-C embodiments to receive the user data from a user equipment (UE) for the host.
50. The host of the previous 2 embodiments, wherein:
   the processing circuitry of the host is configured to execute a host application that receives the user data; and
   the host application is configured to interact with a client application executing on the UE, the client application being associated with the host application.
51. The host of the any of the previous 2 embodiments, wherein the initiating receipt of the user data comprises requesting the user data.
52. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group A-C embodiments to receive the user data from the UE for the host.
53. The method of the previous embodiment, further comprising at the network node, transmitting the received user data to the host.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-50. (canceled)

51. A method performed by a central unit-control plane (CU-CP) network node, the method comprising:
sending, to a central unit-user plane (CU-UP) network node a message identifying a configuration of the CU-UP network node for a Layer 1/Layer 2-triggered mobility (LTM) cell switch procedure by a User Equipment (UE).

52. The method of claim 51, further comprising:
sending, to the CU-UP network node, an indication that the LTM cell procedure has been executed by the UE.

53. The method of claim 52, wherein the indication is sent via E1AP signaling.

54. The method of claim 51, further comprising:
receiving, from the CU-UP network node, one or more transport network layer (TNL) addresses that have been assigned to one or more LTM candidate target cells for the LTM cell switch procedure.

55. The method of claim 54, wherein the one or more TNL addresses consist of one TNL address.

56. The method of claim 54, wherein the one or more TNL addresses are collectively assigned to each of the one or more LTM candidate target cells.

57. The method of claim 54, further comprising sending, to the CU-CP network node, a mapping indicating the assignment between the one or more TNL addresses and the one or more LTM candidate target cells.

58. The method of claim 54, wherein the one or more TNL addresses are uplink TNL addresses.

59. The method of claim 54, the method further comprising:
receiving, from the CU-UP network node, a status associated with the one or more TNL addresses.

60. The method of claim 59, wherein the status associated with the one or more TNL addresses indicates that the one or more TNL addresses are not to be used unless indicated otherwise, and/or are only to be used after a UE performs a LTM cell switch procedure to one of the one or more LTM candidate target cells.

61. A method performed by a central unit-user plane (CU-UP) network node, the method comprising:
receiving, from a central unit-control plane (CU-CP) network node, a message identifying a configuration of the CU-UP network node for a Layer 1/Layer 2-triggered mobility, LTM cell switch procedure by a User Equipment (UE); and
assigning one or more transport network layer (TNL) addresses to one or more LTM candidate target cells for the LTM cell switch procedure.

62. The method of claim 61, further comprising:
sending, to the CU-CP network node, the one or more TNL addresses.

63. The method of claim 62, wherein the one or more TNL addresses are comprised within a BEARER CONTEXT MODIFICATION RESPONSE message, or a BEARER CONTEXT SETUP RESPONSE message.

64. The method of claim 61, wherein the one or more TNL addresses consist of one TNL address.

65. The method of claim 61, wherein the one or more TNL addresses are collectively assigned to each of the one or more LTM candidate target cells.

66. The method of claim 61, further comprising:
sending, to the CU-CP network node, a mapping indicating the assignment between the one or more TNL addresses and the one or more LTM candidate target cells.

67. A method performed by a distributed unit (DU) network node, the method comprising:
receiving, from a central unit-control plane (CU-CP) network node, one or more transport network layer (TNL) addresses that have been assigned to one or more Layer 1/Layer 2-triggered mobility (LTM) candidate target cells of the DU network node.

68. The method of claim 67, the method further comprising:
receiving, from the CU-UP network node, a status associated with the one or more TNL addresses.

69. The method of 68, wherein the status associated with the one or more TNL addresses indicates that the one or more TNL addresses are not to be used unless indicated otherwise.

70. The method of claim 67, wherein the one or more TNL addresses and/or the status are comprised within a UE CONTEXT MODIFICATION REQUEST message.

71. A central unit-control plane (CU-CP) network node, the CU-CP network node comprising a processor and a memory, the memory containing instructions executable by the processor such that the CU-CP network node is operable to:
send, to a central unit-user plane (CU-UP) network node, a message identifying a configuration of the CU-UP network node for a Layer 1/Layer 2-triggered mobility (LTM) cell switch procedure by a User Equipment (UE).
